(19) United States
(12) Patent Application Publication
(10) Pub. No.: US 2021/0270622 A1
(43) Pub. Date: Sep. 2, 2021

(54) TECHNOLOGIES FOR ENERGY SOURCE SCHEDULE OPTIMIZATION FOR HYBRID ARCHITECTURE VEHICLES

(71) Applicant: CUMMINS ENTERPRISE LLC, Indianapolis, IN (US)

(72) Inventors: Avinash VALLUR RAJENDRAN, Indianapolis, IN (US); Vivek Anand SUJAN, Columbus, IN (US)

(21) Appl. No.: 17/172,974

(22) Filed: Feb. 10, 2021

Related U.S. Application Data
(60) Provisional application No. 62/982,410, filed on Feb. 27, 2020.

(51) Int. Cl. G01C 21/34; G07C 5/08; G07C 5/00; G05B 15/02; G01C 21/36; B60K 6/24; B60K 6/26; B60K 6/28; B60K 6/32

(52) U.S. Cl. CPC G01C 21/3469; G07C 5/08; G07C 5/006; G05B 15/02; G06Q 10/06312; B60K 6/24; B60K 6/26; B60K 6/28; B60K 6/32; G01C 21/3626

(57) ABSTRACT

Technologies for energy consumption optimization include a computing device in communication with a fuel cell electric vehicle (FCEV) or other hybrid architecture vehicle. The computing device receives mission parameters and an optimization objective associated with the FCEV and cost information associated with external energy sources. Each external energy source corresponds to an onboard energy storage device of the FCEV. The computing device determines an optimized energy source schedule based on the mission parameters, the optimization objective, and the cost information using a vehicle model of the FCEV. The optimized energy source schedule is indicative of supplying one or more of the onboard energy storage devices with energy from the associated external energy source. The computing device may recommend a component replacement for the FCEV using a component aging model. Other embodiments are described and claimed.

### CROSS-REFERENCE TO RELATED APPLICATIONS

This application claims the benefit of priority under 35 U.S.C. § 119 to U.S. Provisional Patent Application Ser. No. 62/982,410, filed on Feb. 27, 2020, the disclosure of all of which is hereby expressly incorporated herein by reference in its entirety.

### BACKGROUND

This disclosure relates generally to the hybrid vehicle field, and more particularly to fuel cell electric vehicles and methods for operating fuel cell electric vehicles.

Fuel cells are electro-chemical devices which can convert chemical energy from a fuel, such as hydrogen, into electrical energy through an electro-chemical reaction of the fuel with an oxidizer, such as oxygen contained in the atmospheric air. Fuel cell systems are being widely developed as an energy supply system because fuel cells are environmentally superior and highly efficient. To improve system efficiency and fuel utilization and reduce external water usage, the fuel cell system usually includes an anode recirculation loop. Typically, multiple fuel cells are stacked together (usually referred to as a fuel cell stack) to achieve a desired voltage.

Fuel cell electric vehicles (FCEV) typically employ a series hybrid architecture in which a fuel cell is used together with a battery to provide electrical power to an electric drive system. Typical FCEVs include a hydrogen storage tank that may be refilled at a hydrogen fueling station. Additionally, certain FCEVs may support charging the battery from an external electrical source. Thus, FCEVs may support multiple different energy sources with differing costs and resupply characteristics.

### SUMMARY

According to one aspect of this disclosure, a computing device for energy consumption optimization includes an operator interface, an energy information interface, and an energy schedule optimizer. The operator interface is to receive mission parameters associated with a hybrid architecture vehicle having a plurality of onboard energy storage devices and receive an optimization objective associated with the hybrid architecture vehicle. The energy information interface is to receive cost information associated with a plurality of external energy sources, wherein each external energy source is associated with an onboard energy storage device of the hybrid architecture vehicle. The energy schedule optimizer is to determine an optimized energy source schedule for the hybrid architecture vehicle based on the mission parameters, the optimization objective, and the cost information using a vehicle energy consumption model associated with the hybrid architecture vehicle, wherein the optimized energy source schedule is indicative of supplying one or more of the onboard energy storage devices with energy from the associated external energy source. The operator interface is further to output the optimized energy source schedule.

In an embodiment, the plurality of onboard energy storage devices comprises a fluid storage tank and a battery. In an embodiment, the hybrid architecture vehicle comprises a fuel cell electric vehicle, and wherein the plurality of onboard storage devices comprises a hydrogen storage tank and a battery. In an embodiment, the hybrid architecture vehicle comprises an internal combustion engine and an electric motor, and wherein the plurality of onboard storage devices comprises a fuel tank and a battery.

In an embodiment, the computing device further includes a vehicle parameters interface to monitor vehicle telematics of the hybrid architecture vehicle in response to outputting the optimized energy schedule. In an embodiment, the computing device further includes a vehicle parameters interface to receive vehicle telematics data indicative of usage of the hybrid architecture vehicle, and a range estimation engine to update the vehicle energy consumption model based on the vehicle telematics data, wherein to update the vehicle energy consumption model comprises to update a component aging model based on the vehicle telematics data. In an embodiment, to determine the optimized energy source schedule comprises to recommend a component replacement using the component aging model.

In an embodiment, to output the optimized energy source schedule comprises to display a cost benefit associated with the optimized energy source schedule compared to a baseline schedule. In an embodiment, to receive the mission parameters comprises to receive one or more route parameters associated with the hybrid architecture vehicle. In an embodiment, to receive the optimization objective comprises to receive an optimization objective selected from net cost of operation per mile, uptime, component lifetime, total cost of ownership, and range.

In an embodiment, the computing device may be embodied as a vehicle computer of the hybrid architecture vehicle. In an embodiment, to output the optimized energy source schedule comprises to transmit the optimized energy source schedule from the computing device to a vehicle computer of the hybrid architecture vehicle.

According to another aspect, a method for energy consumption optimization includes receiving, by a computing device, mission parameters associated with a hybrid architecture vehicle having a plurality of onboard energy storage devices; receiving, by the computing device, an optimization objective associated with the hybrid architecture vehicle; receiving, by the computing device, cost information associated with a plurality of external energy sources, wherein each external energy source is associated with an onboard energy storage device of the hybrid architecture vehicle; determining, by the computing device, an optimized energy source schedule for the hybrid architecture vehicle based on the mission parameters, the optimization objective, and the cost information using a vehicle energy consumption model associated with the hybrid architecture vehicle, wherein the optimized energy source schedule is indicative of supplying one or more of the onboard energy storage devices with energy from the associated external energy source; and outputting, by the computing device, the optimized energy source schedule.

In an embodiment, the method further includes monitoring, by the computing device, vehicle telematics of the hybrid architecture vehicle in response to outputting the optimized energy schedule. In an embodiment, the method further includes receiving, by the computing device, vehicle telematics data indicative of usage of the hybrid architecture vehicle; and updating, by the computing device, the vehicle energy consumption model based on the vehicle telematics data, wherein updating the vehicle energy consumption model comprises updating a component aging model based on the vehicle telematics data. In an embodiment, determining the optimized energy source schedule comprises recommending a component replacement using the component aging model.

According to another aspect, one or more computer-readable storage media comprising a plurality of instructions stored thereon that, in response to being executed, cause a computing device to receive mission parameters associated with a hybrid architecture vehicle having a plurality of onboard energy storage devices; receive an optimization objective associated with the hybrid architecture vehicle; receive cost information associated with a plurality of external energy sources, wherein each external energy source is associated with an onboard energy storage device of the hybrid architecture vehicle; determine an optimized energy source schedule for the hybrid architecture vehicle based on the mission parameters, the optimization objective, and the cost information using a vehicle energy consumption model associated with the hybrid architecture vehicle, wherein the optimized energy source schedule is indicative of supplying one or more of the onboard energy storage devices with energy from the associated external energy source; and output the optimized energy source schedule.

In an embodiment, the one or more computer-readable storage media further include a plurality of instructions stored thereon that, in response to being executed, cause the computing device to monitor vehicle telematics of the hybrid architecture vehicle in response to outputting the optimized energy schedule. In an embodiment, the one or more computer-readable storage media further include a plurality of instructions stored thereon that, in response to being executed, cause the computing device to receive vehicle telematics data indicative of usage of the hybrid architecture vehicle; and update the vehicle energy consumption model based on the vehicle telematics data, wherein to update the vehicle energy consumption model comprises updating a component aging model based on the vehicle telematics data. In an embodiment, to determine the optimized energy source schedule comprises to recommend a component replacement using the component aging model.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a simplified block diagram of at least one embodiment of a system for energy source schedule optimization for a hybrid architecture vehicle;

FIG. 2 is a simplified block diagram of at least one embodiment of an environment that may be established by a computing device of the system of FIG. 1;

FIG. 3 is a simplified flow diagram of at least one embodiment of a method for energy source schedule optimization that may be executed by the computing device of FIGS. 1-2; and

FIG. 4 is a schematic diagram illustrating an optimized energy source schedule that may be generated by method of FIG. 3.

### DETAILED DESCRIPTION OF THE DRAWINGS

Embodiments of the present disclosure will be described hereinbelow with reference to the accompanying drawings. In the following description, well-known functions or constructions are not described in detail to avoid obscuring the disclosure in unnecessary detail.

Unless defined otherwise, technical and scientific terms used herein have the same meaning as is commonly understood by one of ordinary skill in the art to which this disclosure belongs. The terms “first,” “second,” “third,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including,” “comprising,” or “having” and variations thereof herein are meant to encompass the items listed thereafter and equivalents thereof as well as additional items. In addition, the terms “connected” and “coupled” are not restricted to physical or mechanical connections or couplings, and can include electrical connections or couplings, whether direct or indirect.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. Furthermore, the disclosed embodiments may be initially encoded as a set of preliminary instructions (e.g., encoded on a machine-readable storage medium) that may require preliminary processing operations to prepare the instructions for execution on a destination device. The preliminary processing may include combining the instructions with data present on a device, translating the instructions to a different format, performing compression, decompression, encryption, and/or decryption, combining multiple files that include different sections of the instructions, integrating the instructions with other code present on a device, such as a library, an operating system, etc., or similar operations. The preliminary processing may be performed by the source compute device (e.g., the device that is to send the instructions), the destination compute device (e.g., the device that is to execute the instructions), or an intermediary device. A machine-readable storage medium may be embodied as any storage device, mechanism, or other physical structure for storing or transmitting information in a form readable by a machine (e.g., a volatile or non-volatile memory, a media disc, or other media device).

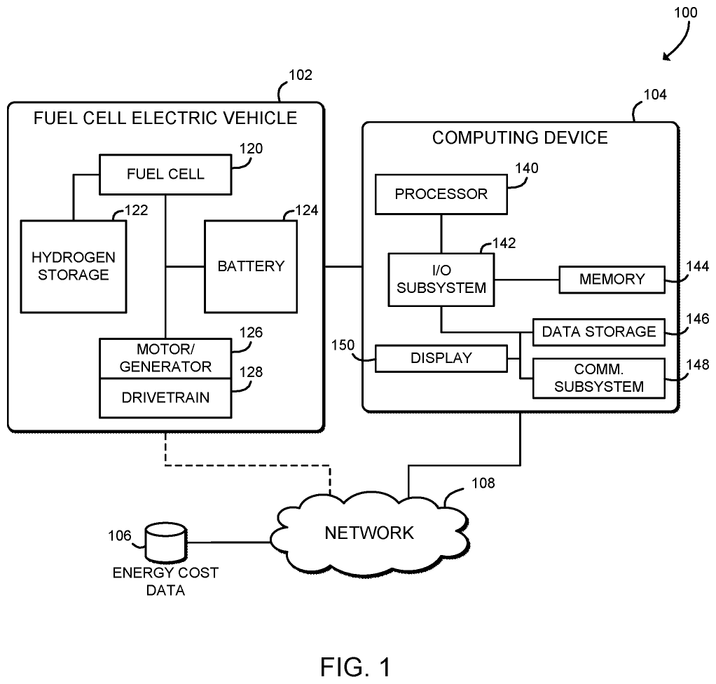

Referring now to FIG. 1, a system 100 for energy source schedule optimization includes a fuel cell electric vehicle (FCEV) 102 in communication with a computing device 104. The computing device 104 and/or the FCEV 102 are communication with an energy cost data source 106 and other remote devices over a network 108. In use, as described further below, a vehicle driver, owner, or other operator provides a vehicle mission and an optimization objective (i.e., an operating metric to be optimized) to the computing device 104. The computing device 104 determines an optimal schedule for refueling and/or recharging the FCEV 102 based on the operator requirements, characteristics of the FCEV 102 (such as component aging information), and real-time energy costs retrieved from the energy cost data source 106. The vehicle operator operates the FCEV 102 according to the provided energy source schedule, for example by refueling and/or recharging the vehicle at specified times and locations using a specified energy source (e.g., hydrogen or electricity). The system 100 may track performance of the FCEV 102 and compare actual cost savings to a baseline and to the optimized energy source schedule. The system 100 thus allows the operator to optimize operation of the FCEV 102 by improving efficiency, reducing operating costs, increasing component lifespan, or otherwise improving a desired operating metric of the FCEV 102.

The FCEV 102 may be embodied as any type of vehicle capable of performing the functions described herein, including, without limitation, a heavy truck, a transit bus, a light truck, a car, a locomotive, an airplane, or other vehicle. As shown in FIG. 1, the FCEV 102 includes a fuel cell 120, a hydrogen storage tank 122, a battery 124, a motor/generator 126, and a drivetrain 128. Of course, the FCEV 102 may include other or additional components such as those typically found in an over-the-road truck or other vehicle. The fuel cell 120 is illustratively a proton exchange membrane (PEM) fuel cell, although in other embodiments the fuel cell may be embodied as a low temperature fuel cell, such as a direct methanol fuel cell, a high temperature fuel cell, such as a solid oxide fuel cell or a molten carbonate fuel cell, or any other fuel cell. The fuel cell 120 reacts hydrogen fuel from the hydrogen fuel tank 122 with ambient oxygen from the air to generate electrical power. The battery 124 may be embodied as a collection of lithium ion battery cells or other rechargeable battery cells. The battery 124 may be charged using electrical power supplied by the fuel cell 120 or using electrical power supplied from an external power source.

As shown, the fuel cell 120 and the battery 124 are coupled to the motor/generator 126. The motor/generator 126 may be embodied as a brushless DC motor, an AC motor, or other electric machine capable of performing the functions described herein. When operating as a motor, the motor/generator 126 converts electrical energy provided by the fuel cell 120 and/or the battery 124 into rotational kinetic energy that is provided to the drivetrain 128. The drivetrain 128 may include a gearbox, differential, axle(s), wheel(s), and/or other components to drive the FCEV 102. When operating as a generator, for example during regenerative braking, the motor/generator 126 converts rotational kinetic energy from the drivetrain 128 into electrical energy that may be used to recharge the battery 124. The FCEV 102 may also include one more motor controllers, electrical inverters, electronic control units (ECUs), or other components for managing electrical power.

Additionally, although illustrated as a FCEV 102, it should be understood that the concepts of this disclosure may apply to any hybrid architecture vehicle that includes multiple onboard energy storage devices having different resupply characteristics and/or energy costs. For example, the concepts of this disclosure also apply to hybrid vehicles that include a diesel engine, gas turbine, or other internal combustion engine in combination with an electric drive system including a motor and battery. Similar to a FCEV 102, such hybrid vehicles also include a relatively fast-filling fuel tank (e.g., a diesel fuel tank, a gasoline fuel tank, a natural gas tank, or other conventional fluid fuel storage tank) and a relatively slow-charging battery.

The computing device 104 may be embodied as any type of computation or computer device capable of performing the functions described herein, including, without limitation, a computer, a tablet computer, a mobile computing device, an in-vehicle infotainment device, a server, a workstation, a desktop computer, a laptop computer, a notebook computer, a wearable computing device, a network appliance, a web appliance, a distributed computing system, a processor-based system, and/or a consumer electronic device. As shown in FIG. 1, the computing device 104 illustratively include a processor 140, an input/output subsystem 142, a memory 144, a data storage device 146, and a communication subsystem 148, and/or other components and devices commonly found in a tablet computer or similar computing device. Of course, the computing device 104 may include other or additional components, such as those commonly found in a tablet computer (e.g., various input/output devices), in other embodiments. Additionally, in some embodiments, one or more of the illustrative components may be incorporated in, or otherwise form a portion of, another component. For example, the memory 144, or portions thereof, may be incorporated in the processor 140 in some embodiments. Additionally, in some embodiments, the computing device 104 may be embodied as a “virtual server” formed from multiple computing devices distributed across the network 108 and operating in a public or private cloud. Accordingly, although the computing device 104 is illustrated in FIG. 1 as embodied as a single computing device, it should be appreciated that the computing device 104 may be embodied as multiple devices cooperating together to facilitate the functionality described below. Further, although illustrated as separate devices, it should be understood that in some embodiments the computing device 104 may be included in or otherwise coupled to the FCEV 102, for example as a vehicle computer with an in-cab display.

The processor 140 may be embodied as any type of processor capable of performing the functions described herein. Similarly, the memory 144 may be embodied as any type of volatile or non-volatile memory or data storage capable of performing the functions described herein. In operation, the memory 144 may store various data and software used during operation of the computing device 104 such as operating systems, applications, programs, libraries, and drivers. As shown, the processor 140 is communicatively coupled to the I/O subsystem 142, which may be embodied as circuitry and/or components to facilitate input/output operations with the processor 140, the memory 144, and other components of the computing device 104. For example, the I/O subsystem 142 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 144 may be directly coupled to the processor 140, for example via an integrated memory controller hub. Additionally, in some embodiments, the I/O subsystem 142 may form a portion of a system-on-a-chip (SoC) and be incorporated, along with the processor 140, the memory 144, and/or other components of the computing device 104, on a single integrated circuit chip.

The data storage device 146 may be embodied as any type of device or devices configured for short-term or long-term storage of data such as, for example, memory devices and circuits, memory cards, hard disk drives, solid-state drives, non-volatile flash memory, or other data storage devices. The computing device 104 also includes the communication subsystem 148, which may be embodied as any communication circuit, device, or collection thereof, capable of enabling communications between the computing device 104 and other remote devices over the computer network 108. The communication subsystem 148 may be configured to use any one or more communication technology (e.g., wired or wireless communications) and associated protocols (e.g., Ethernet, InfiniBand®, Bluetooth®, Wi-Fi®, WiMAX, 3G, 4G LTE, 5G, etc.) to effect such communication. The computing device 104 may also include any number of additional input/output devices, interface devices, hardware accelerators, and/or other peripheral devices.

The display 150 of the computing device 104 may be embodied as any type of display capable of displaying digital information, such as a liquid crystal display (LCD), a light emitting diode (LED), a plasma display, a cathode ray tube (CRT), or other type of display device. In some embodiments, the display 150 may be coupled to or otherwise include a touch screen or other input device.

The energy cost data source 106 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Thus, the energy cost data source 106 may include components and devices commonly found in a computer or similar computing device, such as a processor, an I/O subsystem, a memory, a data storage device, and/or communication circuitry. Those individual components of the energy cost data source 106 may be similar to the corresponding components of the computing device 104, the description of which is applicable to the corresponding components of the energy cost data source 106 and is not repeated herein so as not to obscure the present disclosure.

The FCEV 102, the computing device 104, and the energy cost data source 106 are configured to transmit and receive data with each other and/or other devices of the system 100 over the network 108. The network 108 may be embodied as any number of various wired and/or wireless networks, or hybrids or combinations thereof. For example, the network 108 may be embodied as, or otherwise include, a local interconnect network (LIN), a controller area network (CAN), an automotive network (e.g., FlexRay), a wired or wireless local area network (LAN), an Ethernet network, and/or a wired or wireless wide area network (WAN). As such, the network 108 may include any number of additional devices, such as additional computers, transceivers, routers, and switches, to facilitate communications among the devices of the system 100.

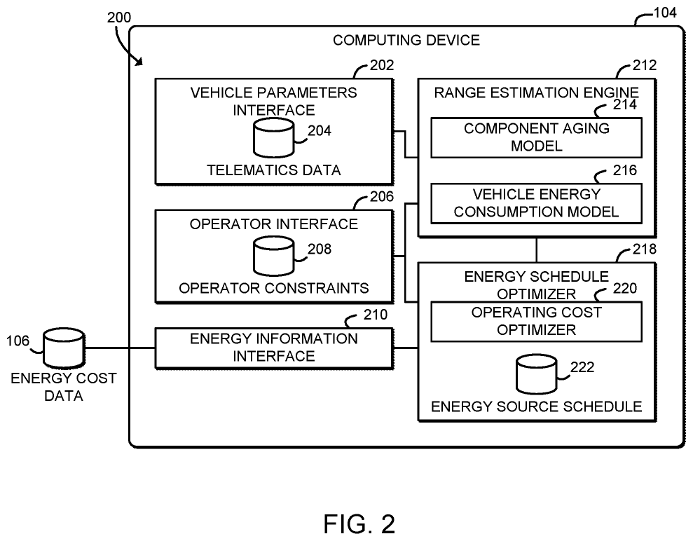

Referring now to FIG. 2, in an illustrative embodiment, the computing device 104 establishes an environment 200 during operation. The illustrative environment 200 includes a vehicle parameters interface 202, an operator interface 206, an energy information interface 210, a range estimation engine 212, and an energy schedule optimizer 218. The various components of the environment 200 may be embodied as hardware, firmware, software, or a combination thereof. As such, in some embodiments, one or more of the components of the environment 200 may be embodied as circuitry or collection of electrical devices (e.g., vehicle parameters interface circuitry 202, operator interface circuitry 206, energy information interface circuitry 210, range estimation engine circuitry 212, and/or energy schedule optimizer circuitry 218). It should be appreciated that, in such embodiments, one or more of the vehicle parameters interface circuitry 202, the operator interface circuitry 206, the energy information interface circuitry 210, the range estimation engine circuitry 212, and/or the energy schedule optimizer circuitry 218) may form a portion of the processor 140, the I/O subsystem 142, and/or other components of the computing device 104. Additionally, in some embodiments, one or more of the illustrative components may form a portion of another component and/or one or more of the illustrative components may be independent of one another.

The vehicle parameters interface 202 is configured to monitor or otherwise receive vehicle telematics data 204 for the FCEV 102. The telematics data 204 is indicative of usage of the FCEV 102. The telematics data 204 may be received from an onboard vehicle telematics system or from a remote system.

The operator interface 206 is configured to receive mission parameters and an optimization objective associated with the FCEV 102. The mission parameters may include one or more route parameters associated with the FCEV 102. The optimization objective may include net cost of operation per mile, uptime, component lifetime, total cost of ownership, or range. The mission parameters and/or the optimization objective may be locked to prevent unauthorized modification.

The energy information interface 210 is configured to receive cost information associated with a plurality of external energy sources. Each external energy source is associated with an onboard energy storage device of the FCEV 102, such as the hydrogen tank 122 and/or the battery 124. The cost information may be received from the energy cost data source 106.

The range estimation engine 212 is configured to update a vehicle energy consumption model 216 based on the vehicle telematics data 204. Updating the vehicle energy consumption model 216 may include updating a component aging model 214 based on the vehicle telematics data 204.

The energy schedule optimizer 218 is configured to determine an optimized energy source schedule 222 for the FCEV 102 based on the mission parameters, the optimization objective, and the cost information using the vehicle energy consumption model 216. The optimized energy source schedule 222 is indicative of supplying one or more of the onboard energy storage devices with energy from the associated external energy source. Determining the optimized energy source schedule may include recommending a component replacement using the component aging model 214.

The operator interface 206 is further configured to output the optimized energy source schedule 222. Outputting the optimized energy source schedule may include displaying a cost benefit associated with the optimized energy source schedule 222 compared to a baseline schedule

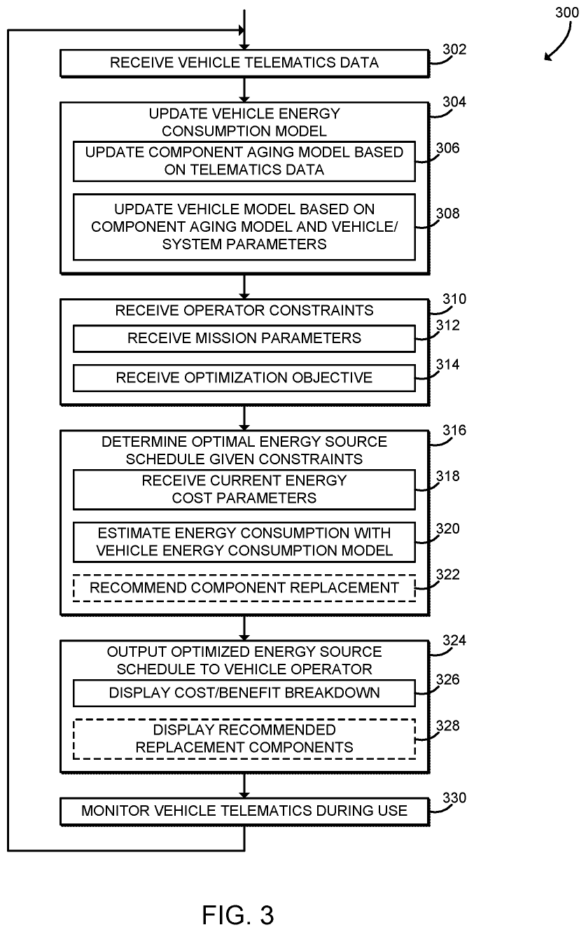

Referring now to FIG. 3, in use, the computing device 104 may execute a method 300 for energy source schedule optimization. It should be appreciated that, in some embodiments, the operations of the method 300 may be performed by one or more components of the environment 200 of the computing device 104 as shown in FIG. 2. The method 300 begins with block 302, in which the computing device 104 receives telematics data 204 for the FCEV 102. The telematics data 204 may include any onboard data generated by the FCEV 102 including data indicative of usage, age, condition, or other characteristics of one or more components of the FCEV 102. For example, the telematics data 204 may include data indicative of battery voltage, battery current, battery temperature, battery state of charge (SOC), fuel cell voltage, fuel cell current, fuel cell hydrogen consumption, fuel cell hydration, or other characteristics. In some embodiments, the telematics data 204 may include or be combined with historical data on operator behavior, battery age monitoring, fuel stack age monitoring, or other data. In some embodiments, the telematics data 204 may include telematics received from one or more remote telematics systems.

In block 304, the computing device 104 updates the vehicle energy consumption model 216. The vehicle energy consumption model 216 may be embodied as any dynamic state estimator or other vehicle model capable of generating estimated energy consumption data for the FCEV 102, such as estimated total energy consumption, estimated energy consumption per mile, estimated range, or other data. In block 306, the computing device 104 updates the component aging model 214 based on the telematics data 204. The component aging model 214 may be embodied as any mathematical model or other component capable of generating powertrain and/or component limits for the FCEV 102 based on the current component aging of the FCEV 102. For example, the component aging model 214 may generate motor torque limits, battery charging current rate, battery discharge current rate, battery energy storage limit, fuel cell power ramp up rate, fuel cell warmup time, estimated energy losses for each component, or other powertrain/component limits for the FCEV 102. In block 308, the computing device 104 updates the vehicle energy consumption model 216 based on the powertrain/component limits generated by the component aging model 214 as well as vehicle/system parameters of the FCEV 102. For example, vehicle or system parameters may include transmission ratios and shift maps, coast down coefficients, availability of advanced powertrain control features, component losses and efficiency, maximum acceleration and deceleration, hydrogen tank 122 capacity, battery 124 capacity, battery 124 voltage-current curves, fuel cell 120 voltage-current curves, system thermal properties, and other parameters. Thus, the updated vehicle energy consumption model 216 may generate accurate energy consumption estimates based on the present state of the FCEV 102, including component aging effects.

In block 310, the computing device 104 receives one or more operator constraints 208. The operator constraints 208 may include one or more route parameters, control parameters, and other operational requirements for the FCEV 102 as well as one or more optimization objectives. The operator constraints 208 may be input by the operator, for example using a touchscreen, onboard telematics, or other input device of the computing device 104. Additionally or alternatively, the operator constraints 208 may be updated by scheduled software update, received from a remote device, or otherwise provided to the computing device 104. In some embodiments, certain operator constraints 208 such as optimization objectives maybe locked to prevent unauthorized modification, such that they may be changed only through telematics or by a service technician or other authorized user. For example, in some embodiments, individual drivers may not be authorized to modify optimization objectives. In those embodiments, a fleet owner/operator may reserve the ability the change optimization objectives.

In block 312, the computing device 104 receives one or more mission parameters that define the particular route, load, or other mission to be performed by the FCEV 102. For example, the mission parameters may include route parameters such as distance, speed limits with respect to distance, grade with respect to distance, locations of stop signs and traffic signals, with respect to distance, predicted time, weight variation with respect to distance, predicted weather conditions, or other route parameters, as well as additional load requirements such as hoteling load with respect to distance, hoteling duration, auxiliary load with respect to distance, or other additional loads. As an illustrative example, a transit bus may have a mission that covers a loop with multiple stops over 6-18 hours per day. As another illustrative example, a heavy truck may have a mission that covers a point to point route. As another example, the mission parameters may include control parameters such as desired depth of discharge for the battery 124, maximum depth of discharge for the battery 124, desired ending state of charge for the battery 124, desired reserve hydrogen level, power split constraints, or other control constraints. In some embodiments, the mission parameters may include fleet operational constraints such as number of stops allowed, maximum trip time, preferred filling stations, intermediate filling allowed, penalty on intermediate filling, geo-fencing constraints, cost vs. time constraints, and productivity/uptime constraints.

In block 314, the computing device 104 receives an optimization objective from the operator. The optimization objective may be embodied as any operational metric of the FCEV 102. As a non-exhaustive example, the optimization objective may be net cost of operation per mile, uptime, system durability (e.g., extending component lifetime), total cost of ownership, range, or other operational metric. In some embodiments, the optimization objective may be a weighted sum of one or more other objectives.

In block 316, the computing device 104 determines an optimal energy source schedule 222 given constraints such as supplied operator constraints 208, powertrain/component limits, and other constraints. The computing device 104 may search and provide an optimal mix of energy sources required for a particular trip. The energy source schedule 222 may include recommendations for a number and/or location of stops to resupply energy to the FCEV 102, recommendations for the type of energy to resupply (e.g., hydrogen fill or electrical recharge), an updated route, and other energy source recommendations. The computing device 104 may use any appropriate optimization algorithm to generate the energy source schedule 222 that satisfies applicable constraints while optimizing the supplied optimization objective. Given a lack of data regarding mission parameters and/or optimization objective, in some embodiments the computing device 104 may use pre-computed values or may use historical data to derive any required parameters.

In block 318, the computing device 104 receives current energy cost parameters from the energy cost data source 106. The cost parameters may include real-time cost information on electricity, hydrogen, or other energy source used by the FCEV 102, as well as expected future cost values for those energy sources. In some embodiments, the cost parameters may also include other charging or filling parameters such as fill time per kilogram of hydrogen, charging time per kilowatt-hour of electrical energy, location of hydrogen filling stations, location of electrical charging stations, hydrogen filling station wait time, charging station wait time, time of day, charger power rating, and other parameters. The cost information may be used to optimize the energy source schedule 222, for example to optimize for cost per mile or total cost of ownership. By incorporating real-time cost information and expected cost information, the computing device 104 may account for seasonal, daily, or more-frequent fluctuations in energy cost. Additionally, the computing device 104 may also adapt to long-term changes in energy cost.

In block 320, the computing device 104 estimates energy consumption using the vehicle energy consumption model 216. As described above, the vehicle energy consumption model 216 is updated to incorporate vehicle and system parameters as well as powertrain/component limits generated by the component aging model 214. The vehicle energy consumption model 216 generates energy consumption information for the particular mission of the FCEV 102 based on mission parameters, control parameters, powertrain status (e.g., battery 124 state of charge, available hydrogen quantity, battery temperature, fuel cell temperature, vehicle location), and other input parameters. The energy consumption data generated by the vehicle energy consumption model 216 as well as powertrain/component limits generated by the component aging model 214 and energy cost parameters are provided to the operating cost optimizer 220.

The operating cost optimizer 220 generates the optimized energy source schedule 222 based on the input parameters and optimized for the operator-supplied optimization objective. The available energy sources for the FCEV 102 (illustratively, hydrogen filling stations and electrical charging stations) have different characteristics including charge/fill time, cost, availability, durability, etc., and thus may compete differently based on the optimization objective. For example, hydrogen is an increasingly popular zero emissions fuel, but operating costs for hydrogen are currently higher per kilowatt as compared to electricity. However, hydrogen has a faster filling time as compared to electrical charging to achieve the same range. Further, the cost of electricity is dynamic and fluctuates throughout the day and exhibits seasonal variation. Additionally, the cost of hydrogen is expected to generally reduce over time. Thus, the operating cost optimizer 220 may account for tradeoffs between hydrogen filling and battery charging to meet operational targets (e.g., total cost of ownership, range or uptime, cost per mile, or another combination of metrics).

In some embodiments, in block 322, the computing device 104 may recommend replacing one or more components of the FCEV 102 as part of the optimized energy source schedule 222. Many electrical components such as batteries and fuel cells tend to lose performance over their lifespan. For example, the total charge capacity and the maximum current capability of a battery may degrade over many charge-discharge cycles. Similarly, fuel cell performance may also degrade over time. The recommended optimized energy source schedule 222 is based on age compensated component limits determined with the component aging model 214 as described above, and thus reflects known aging behavior of components of the FCEV 102. Additionally, the computing device 104 may recommend replacing one or more aged components of the FCEV 102 in order to restore performance. Similarly, the computing device 104 may recommend replacing one or more components as newer components with increased performance and/or reduced cost become available. For example, when optimizing for total cost of ownership, the computing device 104 may determine that the cost of replacing an aged component (e.g., the fuel cell 120 and/or battery 124) when combined with improved performance of the replacement component provides a lower total cost of ownership as compared to continuing with the aged component.

In block 324, the computing device 104 outputs the optimized energy source schedule 222 to the operator of the FCEV 102. The computing device 104 may display the energy source schedule 222, for example, on the display 150 of the computing device 104, or the computing device 104 may provide the energy source schedule 222 to another device for display. In some embodiments, the energy source schedule 222 may be incorporated in a navigation system or other in-vehicle display of the FCEV 102. In block 326, the computing device 104 displays a cost/benefit breakdown of the optimized energy source schedule 222. The cost/benefit breakdown may display cost and/or efficiency improvements of the optimized energy source schedule 222 as compared to a baseline schedule. In some embodiments, in block 328 the computing device 104 may display one or more recommended replacement components. The computing device 104 may also display a cost/benefit breakdown associated with the replacement components, for example by comparing cost and/or efficiency improvements associated with the replacement components as compared to current components of the FCEV 102. As replacement components change in price over time, the cost/benefit breakdown generated by the computing device 104 also changes. Thus, the computing device 104 may allow the operator to gain better understanding of the benefits and impacts associated with upgrading a component of the FCEV 102 at a given time, even several years after the FCEV 102 has been in service.

In block 330, the computing device 104 monitors vehicle telematics data 204 of the FCEV 102 during use. The operator of the FCEV 102 may perform some or all of the recommended energy resupply stops in the energy source schedule 222. The computing device 104 may monitor the vehicle telematics data 204 to determine actual cost or performance of the FCEV 102 as compared to the energy source schedule 222. The computing device 104 may determine missed opportunity costs by comparing actual performance to the recommendations of the energy source schedule 222. After monitoring the vehicle telematics data 204, the method 300 loops back to block 302, in which the computing device 104 may continue to receive telematics data 204 and update the component aging model 214 and/or vehicle energy consumption model 216.

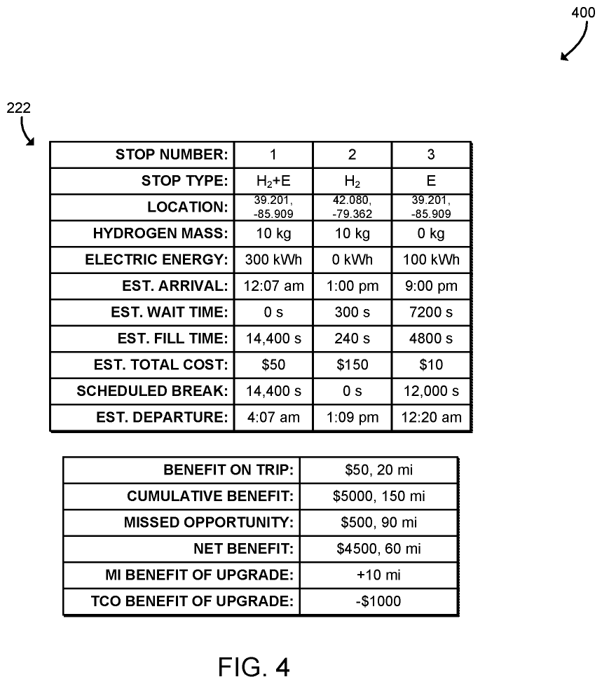

Referring now to FIG. 4, diagram 400 shows an illustrative energy source schedule 222 that may be generated by the computing device 104. The energy source schedule 222 may be displayed by the computing device 104 in tabular form similar to the diagram 400, or may be displayed in a different format, such as in one or more graphs, maps, or other graphical displays. As shown, the energy source schedule includes several predetermined stops for the FCEV 102. Each stop specifies one or more types of energy resupply. For example, stop 1 is hydrogen and electricity, stop 2 is hydrogen only, and stop 3 is electricity only. A location for each stop is specified as a GPS coordinate pair. As shown, the illustrative route is a loop starting at stop 1, traveling to stop 2, and returning to stop 3. Each stop specifies an amount of each type of energy to supply to the FCEV 102, shown as kilograms of hydrogen to fill in the hydrogen tank 122 and/or kilowatt-hours of electrical energy to charge to the battery 124. The energy source schedule 222 also includes estimated arrival times, wait times, fill times, estimated total cost, schedule break times, and estimated departure times. Stops may be scheduled to coincide with scheduled breaks. For example, in the illustrative example, lengthy electrical charge times and estimated wait times are scheduled to coincide with scheduled breaks.

As shown in FIG. 4, the energy source schedule 222 may also include cost/benefit breakdowns for the recommended energy source schedule 222. Cost/benefit information may be displayed by the computing device 104 in tabular form as shown in FIG. 4 or may be displayed in a different format, such as one or more graphs. Illustratively, the energy source schedule 222 is predicted to generate $50 in cost savings and twenty miles in range improvement as compared to a baseline for the current trip. The cumulative benefit, illustratively $5000 and 150 miles, is the gross benefit of following the energy source schedule 222 as compared to the baseline for all trips under ideal conditions. The missed opportunity, illustratively $500 and 90 miles, is losses for actual operation of the FCEV 102 as compared to ideal conditions. Missed opportunity thus accounts for situations in which the operator does not follow the optimized energy source schedule 222. Net benefit, illustratively $4500 and 60 miles, is the net realization of benefit as compared to the baseline. Similarly, energy source schedule 222 may also include impacts of suggested component replacement, such as a replacement battery 124, fuel cell 120, or other component. As shown, the illustrative energy source schedule 222 recommends component upgrades that are predicted to provide 10 miles of increased range and $1000 of reduced TCO.

While steps of the optimization method in accordance with embodiments of the present disclosure are illustrated as functional blocks, the order of the blocks and the separation of the steps among the various blocks shown in FIG. 3 are not intended to be limiting. For example, the blocks may be performed in a different order and a step associated with one block may be combined with one or more other blocks or may be sub-divided into a number of blocks.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

1. A computing device for energy consumption optimization, the computing device comprising:
an operator interface to (i) receive mission parameters associated with a hybrid architecture vehicle having a plurality of onboard energy storage devices and (ii) receive an optimization objective associated with the hybrid architecture vehicle;
an energy information interface to receive cost information associated with a plurality of external energy sources, wherein each external energy source is associated with an onboard energy storage device of the hybrid architecture vehicle; and
an energy schedule optimizer to determine an optimized energy source schedule for the hybrid architecture vehicle based on the mission parameters, the optimization objective, and the cost information using a vehicle energy consumption model associated with the hybrid architecture vehicle, wherein the optimized energy source schedule is indicative of supplying one or more of the onboard energy storage devices with energy from the associated external energy source;
wherein the operator interface is further to output the optimized energy source schedule.

2. The computing device of claim 1, wherein the plurality of onboard energy storage devices comprises a fluid storage tank and a battery.

3. The computing device of claim 1, wherein the hybrid architecture vehicle comprises a fuel cell electric vehicle, and wherein the plurality of onboard storage devices comprises a hydrogen storage tank and a battery.

4. The computing device of claim 1, wherein the hybrid architecture vehicle comprises an internal combustion engine and an electric motor, and wherein the plurality of onboard storage devices comprises a fuel tank and a battery.

5. The computing device of claim 1, further comprising a vehicle parameters interface to monitor vehicle telematics of the hybrid architecture vehicle in response to outputting the optimized energy schedule.

6. The computing device of claim 1, further comprising:
a vehicle parameters interface to receive vehicle telematics data indicative of usage of the hybrid architecture vehicle; and
a range estimation engine to update the vehicle energy consumption model based on the vehicle telematics data, wherein to update the vehicle energy consumption model comprises to update a component aging model based on the vehicle telematics data.

7. The computing device of claim 6, wherein to determine the optimized energy source schedule comprises to recommend a component replacement using the component aging model.

8. The computing device of claim 1, wherein to output the optimized energy source schedule comprises to display a cost benefit associated with the optimized energy source schedule compared to a baseline schedule.

9. The computing device of claim 1, wherein to receive the mission parameters comprises to receive one or more route parameters associated with the hybrid architecture vehicle.

10. The computing device of claim 1, wherein to receive the optimization objective comprises to receive an optimization objective selected from net cost of operation per mile, uptime, component lifetime, total cost of ownership, and range.

11. The computing device of claim 1, wherein the computing device comprises a vehicle computer of the hybrid architecture vehicle.

12. The computing device of claim 1, wherein to output the optimized energy source schedule comprises to transmit the optimized energy source schedule from the computing device to a vehicle computer of the hybrid architecture vehicle.

13. A method for energy consumption optimization, the method comprising:
receiving, by a computing device, mission parameters associated with a hybrid architecture vehicle having a plurality of onboard energy storage devices;
receiving, by the computing device, an optimization objective associated with the hybrid architecture vehicle;
receiving, by the computing device, cost information associated with a plurality of external energy sources, wherein each external energy source is associated with an onboard energy storage device of the hybrid architecture vehicle;
determining, by the computing device, an optimized energy source schedule for the hybrid architecture vehicle based on the mission parameters, the optimization objective, and the cost information using a vehicle energy consumption model associated with the hybrid architecture vehicle, wherein the optimized energy source schedule is indicative of supplying one or more of the onboard energy storage devices with energy from the associated external energy source; and
outputting, by the computing device, the optimized energy source schedule.

14. The method of claim 13, further comprising monitoring, by the computing device, vehicle telematics of the hybrid architecture vehicle in response to outputting the optimized energy schedule.

15. The method of claim 13, further comprising:
receiving, by the computing device, vehicle telematics data indicative of usage of the hybrid architecture vehicle; and
updating, by the computing device, the vehicle energy consumption model based on the vehicle telematics data, wherein updating the vehicle energy consumption model comprises updating a component aging model based on the vehicle telematics data.

16. The method of claim 15, wherein determining the optimized energy source schedule comprises recommending a component replacement using the component aging model.

17. One or more computer-readable storage media comprising a plurality of instructions stored thereon that, in response to being executed, cause a computing device to:
receive mission parameters associated with a hybrid architecture vehicle having a plurality of onboard energy storage devices;
receive an optimization objective associated with the hybrid architecture vehicle;
receive cost information associated with a plurality of external energy sources, wherein each external energy source is associated with an onboard energy storage device of the hybrid architecture vehicle;
determine an optimized energy source schedule for the hybrid architecture vehicle based on the mission parameters, the optimization objective, and the cost information using a vehicle energy consumption model associated with the hybrid architecture vehicle, wherein the optimized energy source schedule is indicative of supplying one or more of the onboard energy storage devices with energy from the associated external energy source; and
output the optimized energy source schedule.

18. The one or more computer-readable storage media of claim 17, further comprising a plurality of instructions stored thereon that, in response to being executed, cause the computing device to monitor vehicle telematics of the hybrid architecture vehicle in response to outputting the optimized energy schedule.

19. The one or more computer-readable storage media of claim 17, further comprising a plurality of instructions stored thereon that, in response to being executed, cause the computing device to:
receive vehicle telematics data indicative of usage of the hybrid architecture vehicle; and
update the vehicle energy consumption model based on the vehicle telematics data, wherein to update the vehicle energy consumption model comprises updating a component aging model based on the vehicle telematics data.

20. The one or more computer-readable storage media of claim 19, wherein to determine the optimized energy source schedule comprises to recommend a component replacement using the component aging model.
